(19) United States
(12) Patent Application Publication
(10) Pub. No.: US 2023/0032129 A1
(43) Pub. Date: Feb. 2, 2023

(54) PARKING ASSISTANCE SYSTEM, MANAGEMENT DEVICE, PORTABLE TERMINAL DEVICE, PARKING ASSISTANCE METHOD, AND NON-TRANSITORY COMPUTER READABLE TANGIBLE STORAGE MEDIUM STORING PARKING ASSISTANCE PROGRAM

(71) Applicant: DENSO CORPORATION, Kariya-city (JP)

(72) Inventors: Takamasa HIDAKA, Kariya-city (JP); Koudai YAMAURA, Kariya-city (JP); Masatake WADA, Kariya-city (JP)

(21) Appl. No.: 17/964,205

(22) Filed: Oct. 12, 2022

Related U.S. Application Data
(63) Continuation of application No. PCT/JP2021/014371, filed on Apr. 2, 2021.

(30) Foreign Application Priority Data
Apr. 14, 2020 (JP) 2020-072254

(51) Int. Cl. B60W 30/06; G05D 1/00; H04W 4/021; G07C 5/08; G06V 20/62; G06K 7/14

(52) U.S. Cl. CPC B60W 30/06; G05D 1/0016; H04W 4/021; G07C 5/0808; G06V 20/625; G06K 7/1417; G05D 2201/0213; G06V 2201/08

(57) ABSTRACT

A parking assistance system for assisting parking of a vehicle includes: an autonomous driving vehicle configured to perform automatic driving from a drop off area in a parking lot to a parking position upon receiving a parking start instruction; a management device configured to manage entering and exiting of the autonomous driving vehicle; and a fixed terminal device installed in the drop off area, the fixed terminal device being operable by a user of the autonomous driving vehicle. The management device includes an intention acquiring unit configured to acquire a parking intention input by the user; an inspection executing unit configured to execute an inspection on the autonomous driving vehicle; an operation requesting unit configured to request the user to perform a predetermined operation through the fixed terminal device; and an instruction transmitting unit configured to transmit the parking start instruction to the autonomous driving vehicle.

### CROSS REFERENCE TO RELATED APPLICATION

The present application is a continuation application of International Patent Application No. PCT/JP2021/014371 filed on Apr. 2, 2021, which designated the U.S. and claims the benefit of priority from Japanese Patent Application No. 2020-072254 filed on Apr. 14, 2020. The entire disclosures of all of the above applications are incorporated herein by reference.

### TECHNICAL FIELD

The present disclosure relates to a parking assistance system configured to assist parking of a vehicle, and a management device, a portable terminal device, a parking assistance method, or a non-transitory computer readable tangible storage medium storing a parking assistance program.

### BACKGROUND ART

A parking assistance system has a well-known automatic valet parking technology that guides an autonomous driving vehicle to move from a drop off area to a parking position in a parking area.

### SUMMARY

One aspect of the present disclosure is a parking assistance system configured to assist parking of a vehicle. The parking assistance system includes the autonomous driving vehicle, a management device, and a fixed terminal device.

The autonomous driving vehicle is configured to automatically drive from the drop off area in a parking lot to a parking position when receiving a parking start instruction. The management device is configured to manage entering and exiting of the autonomous driving vehicle in the parking lot. The fixed terminal device is installed in the drop off area and is operable by a user of the autonomous driving vehicle.

The management device includes an intention acquiring unit, an inspection executing unit, an operation requesting unit, and an instruction transmitting unit. The intention acquiring unit is configured to acquire a parking intention input by the user.

The inspection executing unit is configured to execute an inspection on the autonomous driving vehicle. The operation requesting unit is configured to request the user to perform a predetermined operation through the fixed terminal device when the parking intention is acquired and the inspection is completed. The instruction transmitting unit is configured to transmit the parking start instruction to the autonomous driving vehicle when the predetermined operation is performed through the fixed terminal device.

### BRIEF DESCRIPTION OF DRAWINGS

Objects, features and advantages of the present disclosure will become more apparent from the following detailed description made with reference to the accompanying drawings. In the drawings:

FIG. 1 is a plan view illustrating outline of a parking assistance system;

FIG. 2 is a block diagram illustrating configuration of the parking assistance system;

FIG. 3 is a block diagram illustrating configuration of a control unit of a management device;

FIG. 4 is a block diagram illustrating configuration of a control unit of a portable terminal;

FIG. 5 is a flowchart illustrating process of the portable terminal;

FIG. 6 is a diagram showing an example figure of entering request;

FIG. 7 is a diagram showing an example of a progress image;

FIG. 8 is a diagram showing an example of a readable image;

FIG. 9 is a flowchart illustrating process of a fixed terminal device;

FIG. 10 is a flowchart illustrating parking setting process;

FIG. 11 is a flowchart illustrating automatic parking process; and

FIG. 12 is a plan view schematically illustrating an entry space according to a modified example.

### DESCRIPTION OF EMBODIMENTS

To begin with, a relevant technology will be described first only for understanding the following embodiments. When the parking assistance system is used to assist the autonomous driving vehicle to enter a parking area, it is desirable to perform a pre-entering check to check whether the autonomous driving vehicle is suitable to enter the parking area. However, in view of detailed study conducted by inventor, there is a problem that when the user moves far away from autonomous driving vehicle, the autonomous driving vehicle may occupy a drop off area for a long time. This is because when the pre-entering check of the autonomous driving vehicle fails, the autonomous driving vehicle cannot move from the drop off area.

One aspect of the present disclosure is an automatic valet parking technology that can avoid the autonomous driving vehicle occupying the drop off area for a long time.

A parking assistance system for assisting parking of a vehicle, comprises an autonomous driving vehicle that is configured to perform automatic driving from a drop off area in a parking lot to a parking position upon receiving a parking start instruction, a management device that is configured to manage entering and exiting of the autonomous driving vehicle in the parking lot, and a fixed terminal device that is installed in the drop off area, the fixed terminal device being operable by a user of the autonomous driving vehicle. The management device comprises an intention acquiring unit that is configured to acquire a parking intention input by the user, an inspection executing unit that is configured to execute an inspection on the autonomous driving vehicle, an operation requesting unit that is configured to request the user to perform a predetermined operation through the fixed terminal device when the parking intention is acquired and the inspection is completed, and an instruction transmitting unit that is configured to transmit the parking start instruction to the autonomous driving vehicle when the predetermined operation is performed through the fixed terminal device.

Another aspect of the present disclose is a management device configured to manage entering and exiting of an autonomous driving vehicle in the parking lot. The management device is a part of a parking assistance system for assisting parking of a vehicle. The parking assistance system comprises the autonomous driving vehicle that is configured to perform automatic driving from a drop off area in a parking lot to a parking position upon receiving a parking start instruction; and a fixed terminal device that is installed in the drop off area. The fixed terminal device is operable by a user of the autonomous driving vehicle. The management device comprises an intention acquiring unit that is configured to acquire a parking intention input by the user, an inspection executing unit that is configured to execute an inspection on the autonomous driving vehicle, an operation requesting unit that is configured to request the user to perform a predetermined operation through the fixed terminal device when the parking intention is acquired and the inspection is completed, and an instruction transmitting unit that is configured to transmit the parking start instruction to the autonomous driving vehicle when the predetermined operation is performed through the fixed terminal device.

Yes another aspect of the present disclose is a portable terminal device carried by a user of an autonomous driving vehicle. The portable terminal device constitutes a parking assistance system for assisting parking of a vehicle. The system further comprises the autonomous driving vehicle that is configured to perform automatic driving from a drop off area in a parking lot to a parking position upon receiving a parking start instruction, a fixed terminal device that is installed in the drop off area, the fixed terminal device being operable by the user of the autonomous driving vehicle, and a management device that is configured to manage entering and exiting of the autonomous driving vehicle in the parking lot. The management device comprises an intention acquiring unit that is configured to acquire a parking intention input by the user, an inspection executing unit that is configured to execute an inspection on the autonomous driving vehicle, an operation requesting unit that is configured to request the user to perform a predetermined operation through the fixed terminal device when the parking intention is acquired and the inspection is completed, and an instruction transmitting unit that is configured to transmit the parking start instruction to the autonomous driving vehicle when the predetermined operation is performed through the fixed terminal device. The portable terminal device is configured to communicate with the management device. The portable terminal device comprises a position detecting unit that is configured to detect a position of the portable terminal device, and an input controlling unit that is configured to (a) accept an input of the parking intention when the position of the portable terminal device is within a predetermined area and (b) deny an input of the parking intention when the position of the portable terminal device is out of the predetermined area.

Yet another aspect of the present disclose is a parking assistance method executed by a management device that is a part of a parking assistance system for assisting parking of a vehicle. The parking assistance system comprises an autonomous driving vehicle that is configured to perform automatic driving from a drop off area in a parking lot to a parking position upon receiving a parking start instruction, the management device that is configured to manage entering and exiting of the autonomous driving vehicle in the parking lot, and a fixed terminal device that is installed in the drop off area, the fixed terminal device being operable by a user of the autonomous driving vehicle. The method comprises acquiring a parking intention input by the user, executing an inspection on the autonomous driving vehicle, requesting the user to perform a predetermined operation through the fixed terminal device when the parking intention is acquired and the inspection is completed, and transmitting the parking start instruction to the autonomous driving vehicle when the predetermined operation is performed through the fixed terminal device.

Yet another aspect of the present disclose is a non-transitory computer readable tangible storage medium storing a program executed by a computer included in a portable terminal device, which constitutes a parking assistance system for assisting parking of a vehicle. The parking assistance system comprises an autonomous driving vehicle that is configured to perform automatic driving from a drop off area in a parking lot to a parking position upon receiving a parking start instruction. a fixed terminal device that is installed in the drop off area, the fixed terminal device being operable by a user of the autonomous driving vehicle, a management device that is configured to manage entering and exiting of the autonomous driving vehicle in the parking lot, and a portable terminal device carried by the user of the autonomous driving vehicle is configured to communicate with the management device. The management device comprises an intention acquiring unit that is configured to acquire a parking intention input by the user, an inspection executing unit that is configured to execute an inspection on the autonomous driving vehicle, an operation requesting unit that is configured to request the user to perform a predetermined operation through the fixed terminal device when the parking intention is acquired and the inspection is completed, and an instruction transmitting unit that is configured to transmit the parking start instruction to the autonomous driving vehicle when the predetermined operation is performed through the fixed terminal device. The program comprising instructions, when executed by the computer, causes the computer to perform detecting a position of the portable terminal device; and (a) accepting an input of the parking intention when the position of the portable terminal device is within a predetermined area and (b) denying an input of the parking intention when the position of the portable terminal device is out of the predetermined area.

Yet another aspect of the present disclose is a non-transitory computer readable tangible storage medium storing a parking assistance program executed on a computer included in a management device for managing entering and exiting of an autonomous driving vehicle that is configured to perform automatic driving from a drop off area in a parking lot to a parking position upon receiving a parking start instruction. The portable terminal device is configured to communicate with the management device. The parking assistance program comprises instructions, when executed by the computer, causing the computer to perform acquiring a parking intention input by the user of the autonomous driving vehicle to a portable terminal device, executing an inspection on the autonomous driving vehicle when acquiring the parking intention, requesting the user to perform a predetermined operation through a fixed terminal device installed in the drop off area when the inspection is completed, and transmitting a parking start instruction to the autonomous driving vehicle when the predetermined operation is performed through the fixed terminal device.

According to the above configuration where parking intention is input from the user, since an operation using the fixed terminal device is requested after the inspection, it is possible to keep the user near the fixed terminal device until the inspection is completed. Thus, even if the inspection has failed, the user can immediately return to the autonomous driving vehicle, and thus the autonomous driving vehicle does not occupy the drop off area for a long time.

With reference to the figures, the embodiments of the present publication will be described below.

### 1. Embodiment

[1-1. Configuration of Parking Assistance System 1]

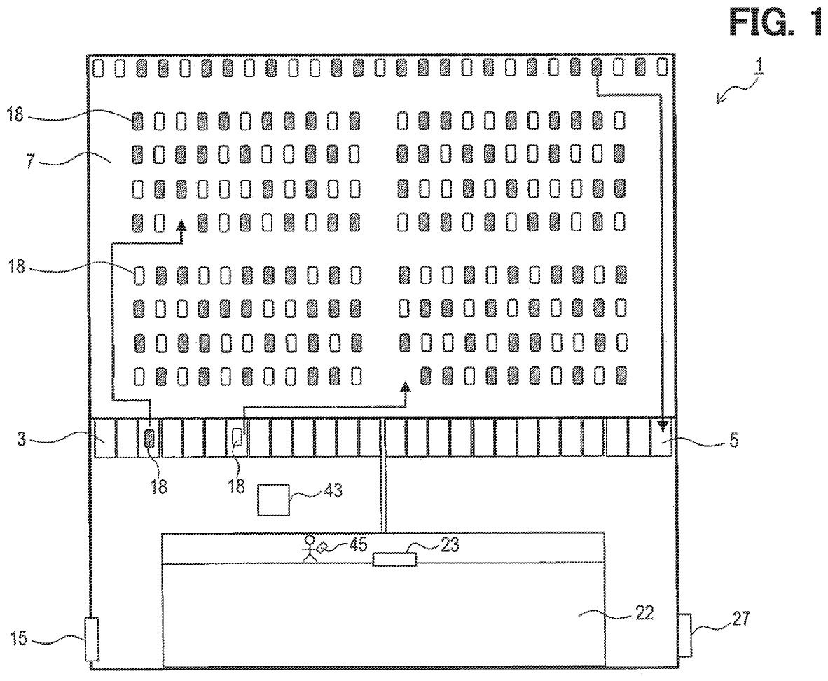

Configuration of the parking assistance system 1 is illustrated based on FIGS. 1-4. As shown in FIG. 1, the parking assistance system 1 includes an entry space 3 in a drop off area for the user to get off, an exit space 5 in a get on area for the user to get on, and a parking area 7. Hereinafter, an area including the entry space 3, the exit space 5 and the parking area 7 is also referred as a parking lot. The entry space 3 and the exit space 5 each includes a plurality of sections. The entry space 3 connects to outside of the parking assistance system 1 via an entrance 15. The autonomous driving vehicle 18 can enter the entry space 3 from the outside via the entrance 15. The autonomous driving vehicle 18 has a function of automatic valet parking.

The autonomous driving vehicle 18 only needs to have the automatic valet parking function within the parking lot. It is not necessary to have automatic driving function out of the parking lot. The automatic valet parking function includes function that automatically drives the autonomous driving vehicle 18 from the entry space 3 to the parking position in the parking area 7, parks the autonomous driving vehicle 18, and automatically drives the autonomous driving vehicle 18 from the parking position in the parking area 7 to the exit space 5.

In particular, the automatic valet parking function includes function that repeatedly acquires location information of the autonomous driving vehicle 18, transmits the location information to the management device 39, acquires the guidance route from the management device 39, and controls the autonomous driving vehicle 18 to move along the guidance route. The position information of the autonomous driving vehicle 18 reflects estimated result of current location of the autonomous driving vehicle 18 (i.e., including coordinates in the parking lot).

The entry space 3 and the exit space 5 is next to an entrance 23 of facilities 22 such as shops. After entering the entry space 3, the passengers of the autonomous driving vehicle 18 can get off from the autonomous driving vehicle 18 and walk to enter the entrance 23.

The exit space 5 is connected to the outside of the parking assistance system 1 via an exit 27. The autonomous driving vehicle 18 moves from the exit space 5 to the outside of the parking assistance system 1 through the exit 27. The passengers can walk to enter the exit space 5 through the entrance 23.

The parking area 7 is an area for a plurality of autonomous driving vehicles 18 to park. There are multiple sections inside the parking area 7. Each of sections defined in the entry space 3, the exit space 5 and parking area 7 is an area allowing one autonomous driving vehicle 18 to park. It is not necessary for the parking area 7 to actually have the multiple sections.

The autonomous driving vehicle 18 is able to move from the entry space 3 to the parking area 7. The autonomous driving vehicle 18 is also able to move from the parking area 7 to the exit space 5.

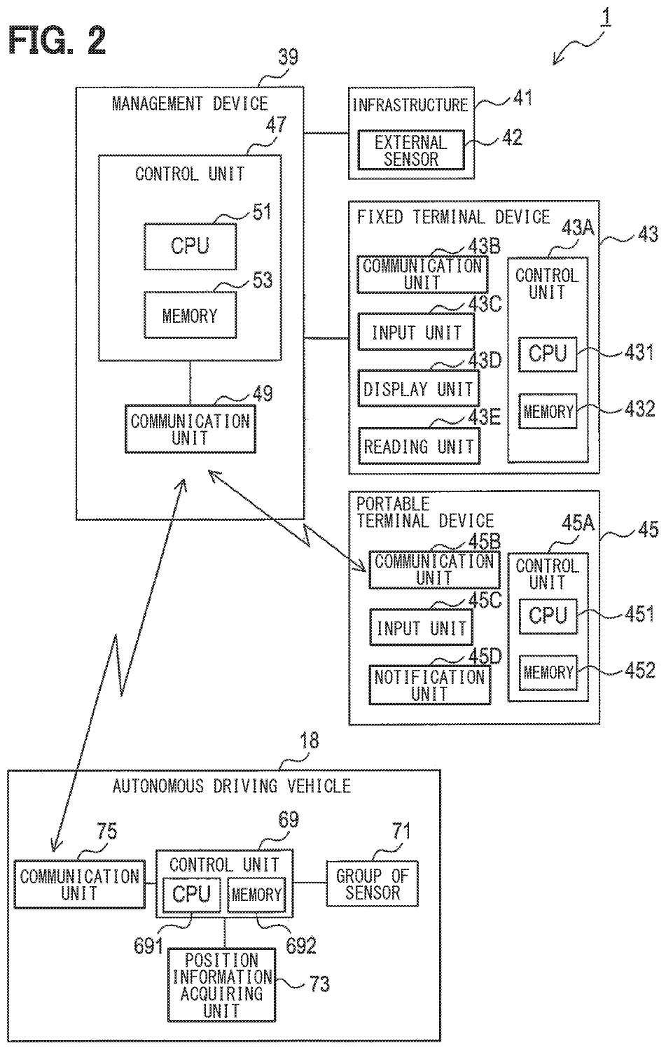

As shown in FIG. 2, the parking assistance system 1 includes a management device 39, an infrastructure 41, a fixed terminal device 43, and a portable terminal device 45.

The management device 39 includes a control unit 47 and a communication unit 49. The control unit 47 includes a microcomputer having a CPU 51 and a semiconductor memory (i.e., a RAM or a ROM) (hereinafter, as referred to as memory 53).

The functions of the control unit 47 are realized by the CPU 51 executing a program stored in a non-transitional substantial recording medium. The program includes a parking assistance program executed by the management device 39. In this example, the memory 53 is the non-transitional substantial recording medium storing the program. By executing the program, a method corresponding to the program is executed. The control unit 47 may include one microcomputer, or include multiple microcomputers.

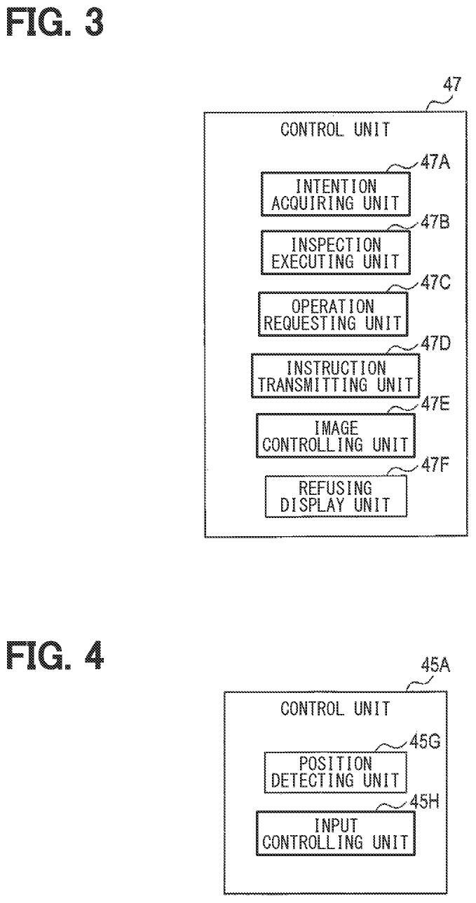

The control unit 47 is configured to transmit the guidance route to the parking position and a parking start instruction to the autonomous driving vehicle 18. As shown in FIG. 3, the control unit 47, for example, includes an intention acquiring unit 47A, an inspection executing unit 47B, an operation requesting unit 47C, an instruction transmitting unit 47D, an image controlling unit 47E, and a refusing display unit 47F. Operations of the units 47A-47F of the control unit 47 will be described later.

The memory 53 stores map information of the parking lot. The map information includes information indicating states of the sections in the parking area 7. The states of the section includes a state indicating vacancy (hereinafter referred to as vacant state) and a state indicating occupation by the autonomous driving vehicle 18 (hereinafter referred to as occupied state). The communication unit 49 communicates with the autonomous driving vehicle 18.

The infrastructure 41 has function of acquiring information indicating a state of the parking assistance system 1 (hereinafter referred to as parking lot information), and apply the parking lot information to the management device 39. The infrastructure 41 includes an external sensor 42 measuring size of vehicles in the entry space 3, a camera taking photos of inside views of the parking lot, LiDAR and so on.

The parking lot information includes, for example, information indicating position of an obstacle, information indicating the states of the sections in the parking area 7, position of the autonomous driving vehicle 18 existing inside the parking assistance system 1, and so on.

As shown in FIG. 1, the fixed terminal device 43C is installed close to the entry space 3. The fixed terminal device 43 includes a control unit 43A, a communication unit 43B, an input unit 43C, a display unit 43D, and a reading unit 43E. A vicinity of the entry space 3 is known as a drop off area (i.e., interior of the entry space 3 and surroundings, which is an area that the user can quickly return to the entry space without making other users waiting).

The control unit 43A receives an input from the passenger and outputs a signal in response to the input to the management device 39. The communication unit 43B communicates with the management device 39. The input unit 43C receives operation from the user. The display unit 43D is a display. The reading unit 43E is a scanner, and is able to read a readable image 45X displayed on the portable terminal device 45 and the like.

The control unit 43A executes fixed terminal process as described below. The fixed terminal process is a process of reading the readable image 45X shown on the portable terminal device 45, and transmitting a reading completion notification to the management device 39 after reading.

The control unit 43A includes a microcomputer having a CPU 431 and a semiconductor memory (i.e., a RAM or a ROM) (hereinafter, as referred to as memory 432). The control unit 43A, for example, in response to the input to the input unit 43C, outputs parking request signal.

The parking request signal is a signal that requests the autonomous driving vehicle 18 in the entry space 3 to move and park in the parking area 7. The fixed terminal device 43 outputs identification of the autonomous driving vehicle 18 when the management device outputs signal corresponding to the input.

The portable terminal device 45 includes a control unit 45A, a communication unit 45B, an input unit 45C, and a notification unit 45D. The portable terminal device 45 is a machine carried by the passenger of the autonomous driving vehicle 18 and configured to communicate with the management device 39. The portable terminal device 45, for example, is a smartphone. The communication unit 45B and the input unit 45C have same function as the communication unit 43B and the input unit 43C of the fixed terminal device 43.

The control unit 45A includes a microcomputer having a CPU 451 and a semiconductor memory i.e., a RAM or a ROM) (hereinafter, as referred to as memory 452). The control unit 45A performing as a computer, as shown in FIG. 4, includes a position detecting unit 45G, and an input controlling unit 45H. The position detecting unit 45G and the input controlling unit 45H will be described later.

The notification unit 45D is configured as a display and a speaker that notifies the passengers with images and sound in response to instructions from the control unit 45A.

As mentioned above, the autonomous driving vehicle 18 has a function of automatic valet parking. As shown in FIG. 2, the autonomous driving vehicle 18 has a control unit 69, a sensor group 71 a position information acquiring unit 73, and a communication unit 75.

The control unit 69 includes a microcomputer having a CPU 691 and a semiconductor memory (i.e., a RAM or a ROM) (hereinafter, as referred to as memory 692). The control unit 69 controls each unit of the autonomous driving vehicle 18. The automatic driving function is implemented by control performed by the control unit 69. The autonomous driving vehicle 18 acquires map information of the parking lot and guidance route from the management device 39, and uses the map information of the parking lot and the guidance route when automatically driving.

The sensor group 71 acquires surrounding information indicating a state around the autonomous driving vehicle 18. The surrounding information includes, for example, positions of obstacles around the autonomous driving vehicle 18 and so on. The sensor group 71 includes, for example, a camera, a LiDAR, and so on. The autonomous driving vehicle 18 uses the surrounding information when automatically driving.

The position information acquiring unit 73 acquires position information of the autonomous driving vehicle 18. The position information acquiring unit 73, for example, has a position estimating system using LiDAR and maps. The autonomous driving vehicle 18 uses position information when automatic driving. The communication unit 75 can execute communication to the management device 39.

[1-2. Process]

Hereinafter, a process of the autonomous driving vehicle entering the parking space is explained.

[1-2-1. Preprocess on the Portable Terminal]

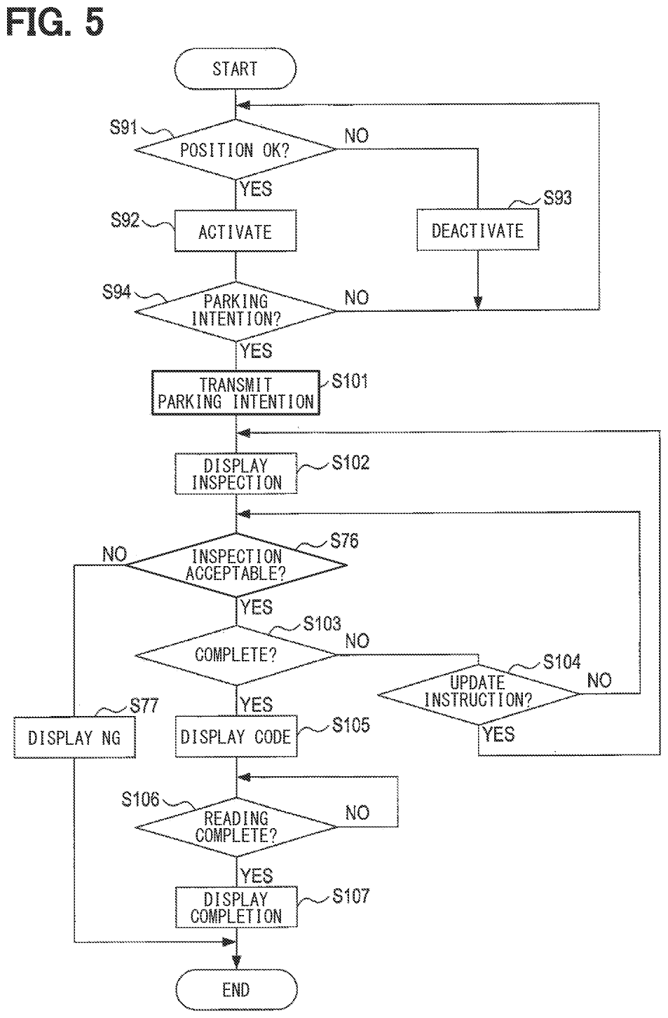

Firstly, a preprocess on the portable terminal executed by the control unit 45a of the portable terminal device 45 is described using the flowchart shown in FIG. 5. The preprocess starts, for example, when an application related to automatic valet parking is started on the portable terminal device 45. Hereinafter, a process executed by the control unit 45a of the portable terminal device 45 (especially the CPU 451) is also described as executed by the portable terminal device 45.

In the preprocess, firstly, in step S91, the position detecting unit 45G of the portable terminal device 45 detects the position of the portable terminal device 45 and determines whether the position of the portable terminal device 45 is within a predetermined range. The position is determined to be within the predetermined range when, for example, the position of the portable terminal device 45 is within at least one of the entry space 3 and a range from the entry space 3 to the entrance 23 of the facility 22.

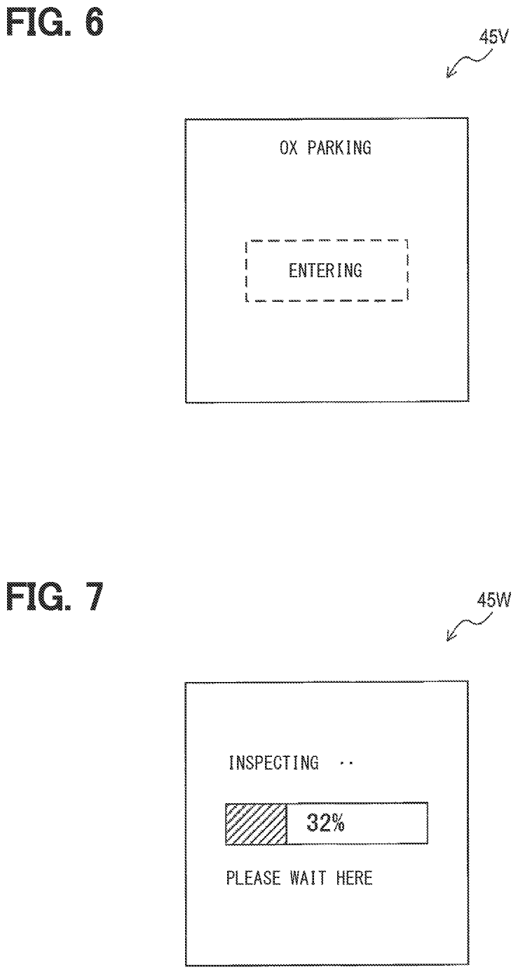

When the position of the portable terminal device 45 is within the predetermined range in step S91, the input controlling unit 45H executes step S92 to activate an input of the parking intention. The activation means, for example, when the input unit 45C is a touch panel, a button on an operating image 45V is operable as shown in FIG. 6. In this case, the portable terminal device 45 displays the button relatively darkly. In other words, the portable terminal device 45 is in a mode where the user is allowed to input the parking intention. The parking intention may be referred to as a “parking instruction”.

On the other hand, when the position of the portable terminal device 45 is out of the predetermined range in step S91, the input controlling unit 45H executes step S93 to deactivate the input of the parking intention. The deactivation means, for example, the button on the operating image 45V is non-operable as shown in FIG. 6. In this case, the portable terminal device 45 displays the button relatively lightly.

In other words, the portable terminal device 45 is in a mode where the input of the parking intention is refused. After step S93, the preprocess returns to step S91. That is, when the position of the portable terminal device is out of the predetermined range, the parking intention is not transmitted.

After step S92, the portable terminal device 45 executes step S94 to determine whether the parking intention has been input. The portable terminal device 45 determines that the parking intention has been input when the button for activating has been pressed by the user.

When the parking intention is determined as not input in step S94, the portable terminal device 45 returns to step S91. When the parking intention is determined as input in step S94, the portable terminal device 45 executes step S101 to transmit the parking intention to the management device 39. The portable terminal device 45 and the management device 39 are in a communication mode by execution of step S101 at the latest.

It is not necessary to execute the steps S91 to S94 in the above mentioned order. For example, the flow as shown below is also acceptable. When the preprocess starts, the button on the operating image 45V is operable, which means to display an activated state. Next, the portable terminal device 45 determines whether or not the parking intention has been input.

When the user presses the button for activating, the preprocess determines whether the parking intention has been input or not. After determining the parking intention has been input, the preprocess determines whether the position of the portable terminal device 45 is within the predetermined range. When the portable terminal device 45 is out of the predetermined range, an error is displayed, for example, a message “Please return to the entry space and start parking” is notified by a notification unit 45D. When the position of the portable terminal device 45 is within the predetermined range, in the step S101, the parking intention is transmitted to the management device 39.

In step S102, the portable terminal device 45 displays inspection in accordance with an instruction from the management device 39. Here, as shown in FIG. 7, the portable terminal device 45 displays a progress image 45W indicative of progress of the inspection. The progress image 45W may include an indicator, graph, loading, and so on that indicate the progress of the inspection with numbers and images. Displayed content is updated every time information related to progress of the inspection transmitted from the management device 39 is updated during the inspection.

In step S76, the portable terminal device 45 determines whether result of the inspection is acceptable or not. The result of the inspection is acceptable when an inspection X and an inspection Y as described later are both not failed. On the other hand, the result of the inspection is not acceptable (that is the result of inspection is unacceptable), when any of the inspection X and the inspection Y as described later has failed. The result of the inspection can be received from the management device 39 after the inspection is completed. The result of the inspection includes acceptance without abnormality, and unacceptance with abnormality.

When the inspection is determined as unacceptable in the step S76, the portable terminal device 45 executes step S77, notifying the notification unit 45D of the unacceptance of the inspection and ends the preprocess. When the inspection in step S76 is determined as acceptable, the portable terminal device 45 executes step S103 to determine whether the inspection has been completed. When the portable terminal device 45 receives a notification that the inspection has been completed from the management device 39, the portable terminal device 45 determines that the inspection has been completed.

When the inspection is determined as not completed in the step S103, the portable terminal device 45 executes step S104 to determine whether instruction for updating the display has been received. When the instruction for updating display has been determined as received in the step S104, the portable terminal device 45 returns to the step S102. On the other hand, when the instruction for updating display has been determined as not received in the step S104, the portable terminal device 45 returns to the step S103.

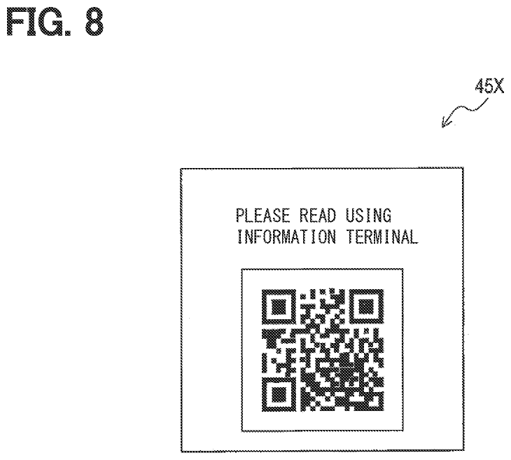

When the inspection is determined as completed in the step S103 and the result of the inspection is acceptable, the portable terminal device 45 executes step S105 to display the readable image 45X on the notification unit 45D. The readable image 45X is a unique readable image that is able to be read by the reading unit 43E of the fixed terminal device 43 and able to be used to identify the portable terminal device 45. The readable image 45X is, as shown in FIG. 8, for example, a two dimensional barcode such as a QR code (registered trademark). Instead of the readable image 45X, an uncontactable IC card and the like that can identify the portable terminal device 45 may also be adopted. Alternatively, instead of using the readable image 45X, near field communication between the portable terminal device 45 and the fixed terminal device 43 may also be adopted. Alternatively, biometric authentication by the user touching scan portion of the fixed terminal device 43 may also be adopted.

In step S106, the portable terminal device 45 determines whether a notification that reading has been completed is received. The reading completion notification is received from the fixed terminal device 43. When the preprocess determines that the reading completion notification has not been received, the portable terminal device 45 returns to step S106.

On the other hand, when the preprocess determines that the reading completion notification has been received, the portable terminal device 45 executes step S107 to display completion of parking on the notification unit 45D. Then, the preprocess as shown in FIG. 5 is completed.

[1-2-2. Preprocess on the Fixed Terminal]

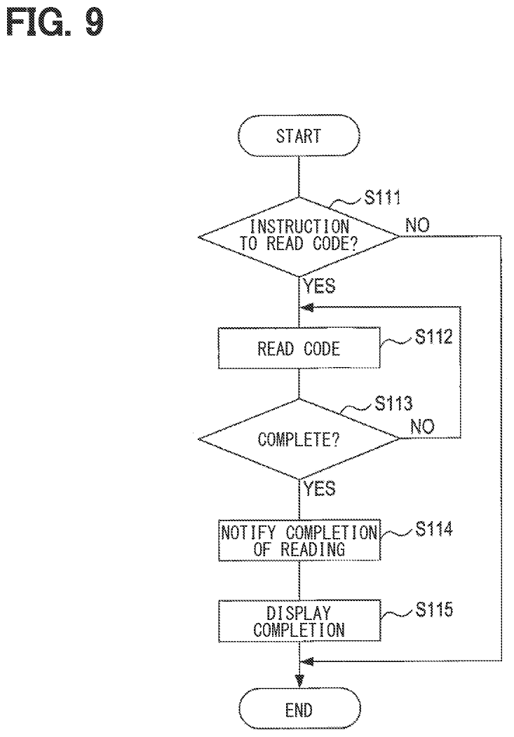

Next, a fixed preprocess on the fixed terminal device 43 is described using the flowchart shown in FIG. 9. The fixed preprocess starts when power of the fixed terminal device is turned on, and then is repeatedly performed. Hereinafter, the process performed by the control unit 43A (specifically the CPU 431) of the fixed terminal device 43 may be also described as performed by the fixed terminal device 43.

In the fixed preprocess, firstly, in step S111, the fixed terminal device 43 determines whether instruction to read the readable image 45X has been input by the user performing operation on the input unit 43C of the fixed terminal device 43. The fixed terminal device 43 completes the fixed preprocess as shown in FIG. 9 when the instruction to read the readable image 45X is determined not to be input in step S111.

On the other hand, when the instruction to read the readable image 45X is determined to be input in step S111, the fixed terminal device 43 executes step S112 to read the readable image 45X (the two dimensional barcode here). Instead of the two dimensional barcode, near field communication between the portable terminal device 45 and the fixed terminal device 43, and biometric authentication by the user touching the scan portion of the fixed terminal device 43 may also be adopted.

In step S113, the fixed terminal device 43 determines whether the reading of the readable image 45X has been completed. When the reading of the readable image 45X is determined as not completed, the fixed terminal device 43 returns to step S112.

On the other hand, when the reading of the readable image 45X is determined as completed, the fixed terminal device 43 executes step S114 to transmit a reading completion notification to the management device 39 and transmit the readable image 45X to the portable terminal device 45. Next, in step S115, after displaying completion of the inspection on the display unit 43D, the fixed terminal device completes the preprocess shown in FIG. 9.

[1-2-3. Parking Setting Process]

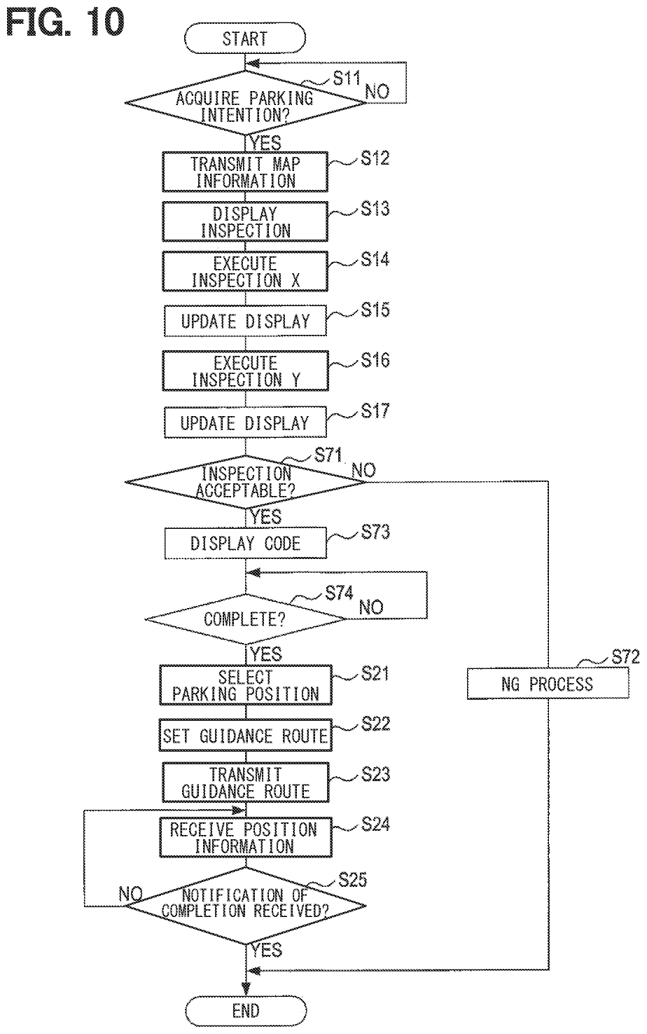

Next, a parking setting process executed by the management device 39 will be described with reference to FIG. 10. The parking setting process, for example, starts when power of the management device 39 is turned on, and thereafter is repeatedly performed. Hereinafter, the process performed by the control unit 47 (specifically the CPU 51) of the management device 39, is also described as performed by the management device 39.

The intention acquiring unit 47A of the management device 39 determines whether the parking request signal has been received as shown in step S11 in the parking setting process illustrated by FIG. 5. Here, when the user inputs parking request on the portable terminal device 45, the portable terminal device transmits the parking request signal corresponding to the input parking request to the management 39. At this time, unique information such as identification ID for identifying the portable terminal device 45, vehicle information such as number plate, vehicle ID, and so on for identifying the vehicle, and user information such as user ID, password, and so on for identifying the user, are transmitted to the management device 39.

In other words, the intention acquiring unit 47A acquires information including at least one of the user ID and vehicle ID as a parking intention. The user inputs necessary information including vehicle information, user information, and so on on the portable terminal device 45, before requesting parking or at each time of requesting parking. When the parking request is not received in step S11, the intention acquiring unit 47A returns to the step S11. When, the parking request is received in step S11, the intention acquiring unit 47A executes step S12.

In step S12, the management device 39 transmits map information of the parking lot to the autonomous driving vehicle 18. Which is to say, the management device 39 transmits the map information of the parking lot to the autonomous driving vehicle 18 when the user inputs an intention of starting parking on the portable terminal device 45.

In step S13, the management device 39 instructs the portable terminal device 45 to display progress of the inspection. In step S14, the inspection X corresponding to a first inspection in the present disclosure is executed. During the inspection X, the autonomous driving vehicle 18 is subject to inspection using the external sensor 42. Specifically, during the inspection X, the external sensor 42 is used to inspect appearance of the autonomous driving vehicle 18. The inspection X includes an inspection as to whether at least one of a vehicle size and a number plate of the vehicle conforms to a standard of the parking lot. When the autonomous driving vehicle 18 does not conform to the standard of the parking lot, the process determines that the inspection X has failed.

The number plate is used, for example, to estimate the size of the vehicle from description of the number plate. The external sensor 42 may have an arbitrary function that is able to scan the vehicle, such as a camera, a radar, and etc. The external sensor 42 can be installed at, for example, any position around the entry space 3.

In step S15, the management device 39 updates the display (i.e., the displayed image) according to the progress of the inspection X. For example, every time when one of inspection items of the inspection X completes, the management device 39 controls the portable terminal 45 to display the progress image 45W with updated number of the percentage of the progress.

In step S16, the management device 39 instructs to execute an inspection Y corresponding to a second inspection in the present disclosure. During the inspection Y, the autonomous driving vehicle 18 is subject to inspection based on a state of the autonomous driving vehicle. Specifically, the inspection Y is conducted based on internal state data or vehicle information and is carried out through communication between the management device 39 and the autonomous driving vehicle 18. The inspection Y includes inspection items to check, as the state of the autonomous driving vehicle 18, whether at least one of a traveling distance (i.e., remaining amount of fuel, remaining amount of battery, and etc.), an error diagnosis, and a type of automatic valet conforms to a predetermined standard that is preset as a parkable state. At this time, the management device 39 acquires the state of the autonomous driving vehicle 18 from the autonomous driving vehicle 18 and inspects the vehicle 18. When the autonomous driving vehicle 18 does not conform to the standard, the management device 39 determines that the inspection Y has failed.

In step S17, the management device 39 updates the display reflecting the progress of the inspection Y, which is same as the process in step S15.

In step S71, the management device 39 determines whether the result of inspection is acceptable. The management device 39 determines that the result of inspection is not acceptable when any one of the inspection X and inspection Y has failed.

When the result of inspection is unacceptable in step S71, the management device 39 executes NG process in step S72. In the NG process, the portable terminal device 45 is notified that the inspection has failed and parking is not possible and is instructed to display the notified messages on the portable terminal device 45. After step S72, the parking setting process is completed.

On the other hand, when the result of inspection is acceptable in step S71, the management device executes step S73 that the image controlling unit 47E of the management device 39 displays the readable image 45X on the portable terminal device 45. By this process, the image controlling unit 47E requests the user to operate the portable terminal device 45 and the fixed terminal device 43 to move closer to each other. Specifically, the image controlling unit 47E requests the fixed terminal device 43 to read the readable image 45X displayed on the portable terminal device 45. Next, the process in FIG. 9 completes.

In step S74, the management device 39 determines whether the reading completion notification has been received. When the reading completion notification has not been received, the management device 39 returns to step S74. When the reading completion notification has been received, the management device 39 executes step S21 and selects the parking position.

A vacant space in the parking area 7 is selected as the parking position. The management device 39 determines a state of each space as follows, for example. When parking in a certain space, the autonomous driving vehicle 18 transmits identification information of the certain space and information of parking start to the management device 39. Further, when leaving the certain space, the autonomous driving vehicle 18 transmits the identification information of the certain space and information of parking end to the management device 39.

The management device 39 determines the state of the space based on history of the information transmitted from the autonomous driving vehicle 18. The management device 39 can also determines the state of the space based on information provided by the infrastructure 41.

When there is only one vacant space, the management device 39 determines the vacant space is the parking position. When there are multiple vacant spaces, the management device 39 selects one of the multiple vacant spaces as the parking position based on a predetermined standard. The predetermined standard includes, for example, a standard for selecting a nearest space to the entry space 3, a standard for selecting a nearest space to the exit space 5, a standard for selecting a space in an area with gathered multiple vacant spaces, and etc.

In step S22, the management device 39 sets a guiding route from the current position of the autonomous driving vehicle 18 to the selected parking position selected in the step S21, based on the map information of the parking lot.

In step S23, the management device 39 transmits information related to the guidance route set in the step S22 (hereinafter referred as guidance route information) to the communication unit 49. The guidance route information also instructs the autonomous driving vehicle 18 to start parking. As described later, the autonomous driving vehicle 18 starts automatic driving when receiving the guidance route information.

In step S24, the management device 39 receives the position information of the autonomous driving vehicle 18. In step S25, the management device 39 determines whether the communication unit 49 has received a completion notification. The completion notification is a notification transmitted by the autonomous driving vehicle 18 when the autonomous driving vehicle 18 parks at the parking position, which is an end location of the guidance route.

When the completion notification is received, the management device 39 ends the process. When the completion notification is not received, the management device 39 returns to the step S24.

[1-2-4. Automatic Parking Process]

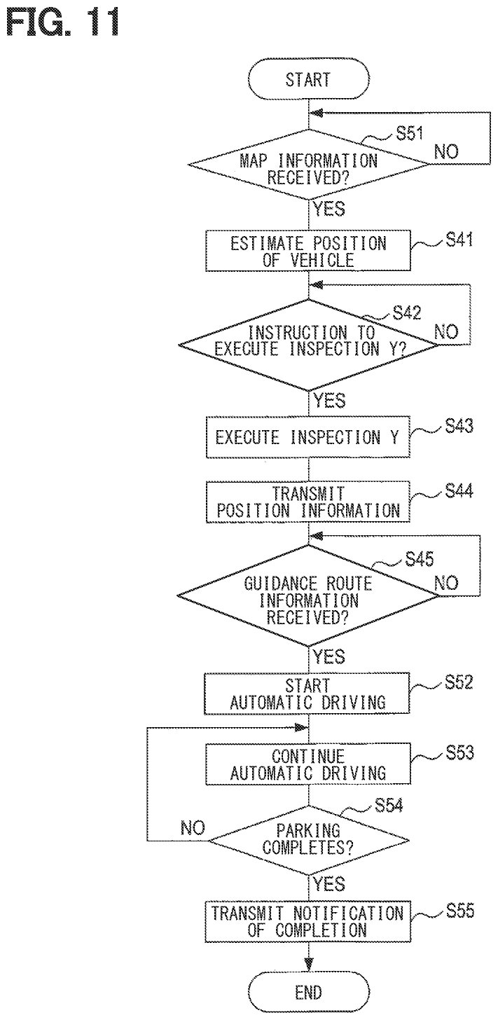

An automatic parking process executed by the autonomous driving vehicle 18 is described with reference to FIG. 11. The automatic parking process is a process that the autonomous driving vehicle 18 automatically travels from the entry space 3 to the parking position based on the parking setting process performed by the management device 39. Hereinafter, the process performed by the control unit 69 (specifically the CPU 691) of the autonomous driving vehicle 18, is also described as performed by the autonomous driving vehicle 18.

In step S51, the autonomous driving vehicle 18 determines whether the communication unit 75 has received the map information of the parking lot. When the map information has not been received, the process returns to the step S51. When the map information has been received, the autonomous driving vehicle 18 executes step S42 to estimate the current position of the autonomous driving vehicle 18. Which is to say, the autonomous driving vehicle 18 estimates the current position of the autonomous driving vehicle 18 after receiving the map information from the management device 39, and transmits the estimated result of the current position to the management device 39.

In step S42, the autonomous driving vehicle 18 determines whether the management device 39 has instructed to execute the inspection Y. When the management device 39 has not instructed to execute the inspection Y, the autonomous driving vehicle 18 returns to the step S42. On the other hand, when the management device 39 has instructed to execute the inspection Y, the autonomous driving vehicle 18 executes step S43 to execute the inspection Y.

In step S44, the autonomous driving vehicle 18 transmits the estimated result of the current position as the position information of the autonomous driving vehicle 18 to the management device 39. Then, in step S45, the autonomous driving vehicle 18 determines whether the guidance route information has been received.

The guidance route information is an information transmitted by the management device 39. When the guidance route information is determined as not received in the step S45, the autonomous driving vehicle 18 returns to the step S45. When the guidance route information is determined as received in step S45, the autonomous driving vehicle 18 executes step S52 to start automatic driving of the autonomous driving vehicle 18. During the automatic driving, the autonomous driving vehicle 18 performs self-driving along a route included in the guidance route information.

In step S53, the autonomous driving vehicle 18 continues the self-driving. The autonomous driving vehicle 18 repeatedly transmits position information of the autonomous driving vehicle 18 until parking is determined as completed in step S54 as described below. The transmitted position information is received by the management device 39.

In step S54, the autonomous driving vehicle 18 determines whether parking has been completed. When the parking has been completed, the autonomous driving vehicle 18 parks at the parking position set by the management device 39. If the parking has not been completed, the process returns to the step S54.

When the parking has been completed, the autonomous driving vehicle 18 executes step S55 to transmit the completion notification using the communication unit 75. The management device 39 receives the completion notification.

[1-3. Advantageous Effects]

The first embodiment as described above, has advantageous effects as shown below.

(1a) One embodiment of the present publication has a parking assistance system 1 configured to assist parking of a vehicle. The parking assistance system 1 comprises an autonomous driving vehicle 18, a management device 38, and a fixed terminal device 43.

The autonomous driving vehicle 18 is configured to automatic drive from the drop off area in the parking lot to the parking position when receiving a parking start instruction. The management device 39 is configured to manage entry and exit of the autonomous driving vehicle 18 in the parking lot. The fixed terminal device 43 is configured to be operable by the user and installed in the drop off area.

The management device 39 includes an intention acquiring unit 47A, an inspection executing unit 47B, an operation requesting unit 47C, and an instruction transmitting unit 47D. The intention acquiring unit 47A is configured to acquire a parking intention input by the user of the autonomous driving vehicle 18 through the portable terminal device 45.

The inspection executing unit 47B is configured to execute the inspection on the autonomous driving vehicle 18 when the parking intention is acquired. The operation requesting unit 47C is configured to request the user to perform a predetermined operation through the fixed terminal device 43 when the inspection is completed. The instruction transmitting unit 47D is configured to transmit the parking start instruction to the autonomous driving vehicle 18 when the predetermined operation is performed through the fixed terminal device 43.

According to the above configuration, since operations on the fixed terminal device 43 are requested after the inspection, it is possible to cause the user to stay close to the fixed terminal device 43 until the inspection is completed. Thus, when the inspection has failed, the user can directly return to the autonomous driving vehicle 18, such that the autonomous driving vehicle 18 does not occupy the drop off area for a long time.

(1b) One embodiment of the present publication further comprises an external sensor 42 installed in the drop off area for inspecting the autonomous driving vehicle 18. The inspection executing unit 47B executes the first inspection for inspecting the autonomous driving vehicle 18 using the external sensor 42, and a second inspection for inspecting the autonomous driving vehicle 18 based on the state of the autonomous driving vehicle 18.

According to the above configuration, two inspections are executed based on the external sensor 42 and the state of the vehicle, such that the autonomous driving vehicle 18 can be inspected with higher accuracy.

(1c) In one embodiment of the present publication, the first inspection includes an inspection to check whether at least one of the vehicle size and the number plate conforms to the standard of the parking lot. The second inspection includes an inspection to check, as the state of the autonomous driving vehicle 18, whether at least one of the traveling distance, the error diagnosis, and the type of automatic valet conforms to the predetermined standard that is preset as the parkable state.

According to the above configuration, it is possible to execute the inspection from the viewpoint as to whether the autonomous driving vehicle 18 conforms to the standard of the parking lot and whether the autonomous driving vehicle 18 can be driven normally.

(1d) One embodiment of the present publication further comprises a portable terminal device 45. The portable terminal device 45 is carried by the user of the autonomous driving vehicle 18 and configured to communicate with the management device 39. The parking intention is configured to be input through the portable terminal device carried by the user.

According to the above configuration, the portable terminal device 45 is configured to allow the user to input the parking intention, and the operation on the fixed terminal device 43 is requested after the inspection, such that the user is caused to stay around the fixed terminal device 43 until the inspection is completed.

(1e) In one embodiment of the present publication, the operation requesting unit 47C requests the user to move the portable terminal 45 closer to the fixed terminal device 43 after inspection has completed. According to the above configuration, since the operation for bringing the portable terminal device 45 and the fixed terminal device 43 closer to each other is requested, the fixed terminal device 43 can identify the user easily.

(1f) One embodiment of the present publication, the management device 39 further includes an image controlling unit 47E that is configured to display a QR code, which is a readable image 45X, on the portable terminal device 45 when the inspection is completed. The fixed terminal device 43 includes a reading unit 43E that is configured to read the readable image 45X.

The operation requesting unit 47C requests an operation to read the readable image 45X displayed on the portable terminal device 45 by the fixed terminal device 43, as the operation requested the user to perform.

According to the above configuration, since the operation to have the fixed terminal device 43 read the readable image 45X displayed on the portable terminal device 45 is requested, the user can be easily identified by the operation to move the portable terminal 45 closer to the fixed terminal device 43.

(1g) In one embodiment of the present publication, the inspection executing unit 47B causes the portable terminal device 45 to display a progress image 45W reflecting the progress of the inspection during the inspection.

According to the above configuration, since the progress image 45W is displayed on the portable terminal device 45, the user can understand the progress of the inspection.

(1h) In one embodiment of the present publication, the intention acquiring unit 47A is configured to acquire information including at least one of a user ID and a vehicle ID as the parking intention.

According to the above configuration, vehicles that would like to park can be verified using the user ID or the vehicle ID.

(1i) In one embodiment of the present publication, the management device 39 further includes a refusing display unit 47F that is configured to display an image indicating that the parking is not possible on the portable terminal device when the inspection determines that the parking is not allowed.

According to the above configuration, the user can be notified by displaying that the parking is impossible when the inspection determines that the parking is not allowed.

(1j) In one embodiment of the present publication, the portable terminal device 45 further includes a position detecting unit 45G and an input controlling unit 45H. The position detecting unit 45G is configured to detect a position of the portable terminal device. The input controlling unit 45H that is configured to (a) accept an input of the parking intention when the position of the portable terminal device is within a predetermined area and (b) deny an input of the parking intention when the position of the portable terminal device is out of the predetermined area.

According to the above configuration, the parking is possible when the position of the portable terminal device 45 is within the predetermined area.

### 2. Other Embodiments

The embodiments of the present disclosure are described above. The present disclosure is not only limited to the embodiments described above, but also can be implemented with various variations.

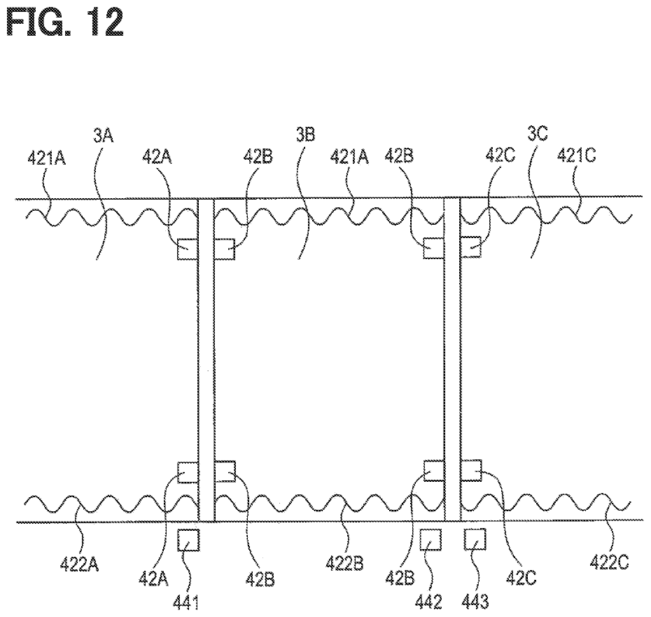

(2a) In the above embodiments, the external sensor 42 is set at any location in the drop off area. The present invention is not limited to this. For example, as shown in FIG. 12, when the entry space 3A, 3B, and 3C are in the drop off area, each of the entry space 3A, 3B, and 3C has plurality of external sensor 42A, 42B, and 42C. In this case, each of the entry space 3A, 3B, and 3A has a shutter 421A, 421B, 421C of facilities (i.e., shops), a shutter 422A, 422B, 422C of the parking area 7, a fixed terminal device 441, 442, 443, and so on.

According to the configuration, during inspection X, after the autonomous driving vehicle 18 enters the entry space, the shutters 431A, 421B and 421C of the entry space 3A, 3B and 3C close. The inspection X can be performed when the user or the like does not enter the entry space 3A, 3B, and 3C. By having plurality of the fixed terminal device 441, 442, and 443, it is possible to reduce waiting time until another user completes his/her operations.

(2b) In the abovementioned embodiments, the portable terminal device 45 executes preprocess on the portable terminal, and the fixed terminal device 43 executes corresponding process. In this case, for example, when the location of the portable terminal device 45 is within the predetermined range, the button on an operating image 45V displayed on the display unit 43D of the fixed terminal device 43 is operable. The progress image as shown in FIG. 7 is displayed on the display unit 43D of the fixed terminal device 43.

(2c) In the abovementioned embodiments, the inspection X is performed in step the S14 and the inspection Y is performed in the step S16. The inspection X and the inspection Y cannot be performed at the same time. In the case of the step S71, the management device 39 determines whether the result of the inspection is acceptable. The management device 39 determines the inspection fails (NG) when any one of the inspection X and inspection Y fails.

(2d) In the abovementioned embodiments, the management device 39 performs inspection X and inspection Y when receiving the parking intention. At least a portion of the inspection X and the inspection Y is performed before the parking intention is transmitted from the portable terminal device 45 to the management device 39. That is, the management device 39 performs at least the portion of the inspection X and the inspection Y before receiving the parking intention.

For example, the management device 39 performs at least the portion of the inspection X and the inspection Y before receiving the parking intention, after the autonomous driving vehicle 18 enters the parking lot, based on the information from infrastructure 41 and stores the result of the inspection.

Alternatively, the management device 39 performs at least the portion of the inspection X and the inspection Y after communication between the management device and the autonomous driving vehicle 18 establishes and before the parking intentions is transmitted. In this case, information related to the state of the autonomous driving vehicle 18 is transmitted from the autonomous driving vehicle 18 to the management device 39. The management device 39 performs at least the portion of the inspection X and the inspection Y using information related to the travelling distance and stores the result of the inspection.

(2e) In the present publication, each of the control units 43A, 45A, 47A and 69 and the corresponding methods may be reached by a specific computer configured with a processor and memory programed to perform one or more functions of a computer program. Alternatively, each of the control unit 43A, 45A, 47A and 69 and the corresponding methods may be reached by a specific computer configured with a processor with at least one specific hardware logic circuit. Alternatively, each of the control units 43A, 45A, 47A and 69 and the corresponding methods may be reached by a specific computer configured with a combination of (1) a processor and memory programed to perform one or more functions of a program, and (2) a processor with at least one specific hardware logic circuit. The computer program is stored in a computer readable, non-transitional substantial recording medium, as instructions executed by the computer. Methods for reaching the functions of each of control unit 43A, 45A, 47A and 69 do not necessarily to include a software. All the functions may be reached by using one or more hardware.

(2f) In the above embodiments, multiple functions performed by one component may be performed by multiple components, or one function performed by one component may be performed by multiple components. Multiple functions performed by multiple components may be performed by one component, and one function performed by one component may be performed by multiple component. A portion of the component of the above embodiment may be omitted. At least a portion of the component of the above embodiment may be added or replaced in accordance with component of other embodiments.

(2g) In addition to the above parking assistance system 1, various embodiments can be used to reach the present publication with the management device 39, the fixed terminal device 43, the portable terminal device 45, and the autonomous driving vehicle 18 as components of the parking assistance system 1, a program for making a computer function as a component of the parking assistance system 1, a non-transitional substantial recording medium (i.e., semiconductor memory and the like recording the program, a parking assistance method and the like.

1. A parking assistance system for assisting parking of a vehicle, the system comprising:
an autonomous driving vehicle that is configured to perform automatic driving from a drop off area in a parking lot to a parking position upon receiving a parking start instruction;
a management device that is configured to manage entering and exiting of the autonomous driving vehicle in the parking lot; and
a fixed terminal device that is installed in the drop off area, the fixed terminal device being operable by a user of the autonomous driving vehicle, wherein
the management device comprises:
an intention acquiring unit that is configured to acquire a parking intention input by the user;
an inspection executing unit that is configured to execute an inspection on the autonomous driving vehicle;
an operation requesting unit that is configured to request the user to perform a predetermined operation through the fixed terminal device when the parking intention is acquired and the inspection is completed; and
an instruction transmitting unit that is configured to transmit the parking start instruction to the autonomous driving vehicle when the predetermined operation is performed through the fixed terminal device.

2. The parking assistance system according to claim 1, further comprising:
an external sensor installed in the drop off area for inspecting the autonomous driving vehicle, wherein
the inspection executing unit is further configured to execute:
a first inspection for inspecting the autonomous driving vehicle using the external sensor; and
a second inspection for inspecting the autonomous driving vehicle based on a state of the autonomous driving vehicle.

3. The parking assistance system according to claim 2, wherein
the first inspection includes an inspection to check whether at least one of a vehicle size and a number plate conforms to a standard of the parking lot, and
the second inspection includes an inspection to check, as the state of the autonomous driving vehicle, whether at least one of a traveling distance, an error diagnosis, and a type of automatic valet conforms to a predetermined standard that is preset as a parkable state.

4. The parking assistance system according to claim 1, further comprising:
a portable terminal device carried by the user of the autonomous driving vehicle, wherein
the portable terminal device is configured to communicate with the management device, and
the parking intention is input through the portable terminal device carried by the user.

5. The parking assistance system according to claim 4, wherein
when the inspection is completed, the operation requesting unit is configured to request the user to perform an operation that is performed by bringing the portable terminal device and the fixed terminal device close to each other.

6. The parking assistance system according to claim 5, wherein
the management device further comprises an image controlling unit that is configured to display a readable image on the portable terminal device when the inspection is completed,
the fixed terminal device further comprises a reading unit that is configured to read the readable image, and
the operation requesting unit is configured to request the user, as the operation, to have the readable image on the portable terminal device read by the fixed terminal device.

7. The parking assistance system according to claim 4, wherein:
the intention acquiring unit is configured to acquire information including at least one of a user ID and a vehicle ID as the parking intention.

8. The parking assistance system according to claim 4, wherein
the management device further comprises a refusing display unit that is configured to display an image indicating that the parking is not possible on the portable terminal device when the inspection determines that the parking is not allowed.

9. The parking assistance system according to claim 4, wherein
the portable terminal device further comprises:
a position detecting unit that is configured to detect a position of the portable terminal device; and
an input controlling unit that is configured to (a) accept an input of the parking intention when the position of the portable terminal device is within a predetermined area and (b) deny an input of the parking intention when the position of the portable terminal device is out of the predetermined area.

10. The parking assistance system according to claim 4, wherein
the inspection executing unit is configured to cause the portable terminal device to display a progress image of the inspection during the inspection.

11. A management device configured to manage entering and exiting of an autonomous driving vehicle in the parking lot, the management device being a part of a parking assistance system for assisting parking of a vehicle, the parking assistance system comprising:
the autonomous driving vehicle that is configured to perform automatic driving from a drop off area in a parking lot to a parking position upon receiving a parking start instruction; and
a fixed terminal device that is installed in the drop off area, the fixed terminal device being operable by a user of the autonomous driving vehicle, the management device comprising:
an intention acquiring unit that is configured to acquire a parking intention input by the user;
an inspection executing unit that is configured to execute an inspection on the autonomous driving vehicle;
an operation requesting unit that is configured to request the user to perform a predetermined operation through the fixed terminal device when the parking intention is acquired and the inspection is completed; and
an instruction transmitting unit that is configured to transmit the parking start instruction to the autonomous driving vehicle when the predetermined operation is performed through the fixed terminal device.

12. A portable terminal device carried by a user of an autonomous driving vehicle, the portable terminal device being a part of a parking assistance system for assisting parking of a vehicle, the system comprising:
the autonomous driving vehicle that is configured to perform automatic driving from a drop off area in a parking lot to a parking position upon receiving a parking start instruction;
a fixed terminal device that is installed in the drop off area, the fixed terminal device being operable by the user of the autonomous driving vehicle; and
a management device that is configured to manage entering and exiting of the autonomous driving vehicle in the parking lot, wherein
the management device comprises:
an intention acquiring unit that is configured to acquire a parking intention input by the user;
an inspection executing unit that is configured to execute an inspection on the autonomous driving vehicle;
an operation requesting unit that is configured to request the user to perform a predetermined operation through the fixed terminal device when the parking intention is acquired and the inspection is completed; and
an instruction transmitting unit that is configured to transmit the parking start instruction to the autonomous driving vehicle when the predetermined operation is performed through the fixed terminal device,
the portable terminal device being configured to communicate with the management device and comprising:
a position detecting unit that is configured to detect a position of the portable terminal device; and
an input controlling unit that is configured to (a) accept an input of the parking intention when the position of the portable terminal device is within a predetermined area and (b) deny an input of the parking intention when the position of the portable terminal device is out of the predetermined area.

13. A parking assistance method executed by a management device that is a part of a parking assistance system for assisting parking of a vehicle, the parking assistance system comprising:
an autonomous driving vehicle that is configured to perform automatic driving from a drop off area in a parking lot to a parking position upon receiving a parking start instruction;
the management device that is configured to manage entering and exiting of the autonomous driving vehicle in the parking lot; and
a fixed terminal device that is installed in the drop off area, the fixed terminal device being operable by a user of the autonomous driving vehicle, the method comprising:
acquiring a parking intention input by the user;
executing an inspection on the autonomous driving vehicle;
requesting the user to perform a predetermined operation through the fixed terminal device when the parking intention is acquired and the inspection is completed; and
transmitting the parking start instruction to the autonomous driving vehicle when the predetermined operation is performed through the fixed terminal device.

14. A non-transitory computer readable tangible storage medium storing a program executed by a computer included in a portable terminal device, which is a part of a parking assistance system for assisting parking of a vehicle, the parking assistance system comprising:
an autonomous driving vehicle that is configured to perform automatic driving from a drop off area in a parking lot to a parking position upon receiving a parking start instruction;
a fixed terminal device that is installed in the drop off area, the fixed terminal device being operable by a user of the autonomous driving vehicle;
a management device that is configured to manage entering and exiting of the autonomous driving vehicle in the parking lot; and
a portable terminal device carried by the user of the autonomous driving vehicle is configured to communicate with the management device, wherein
the management device comprises:
an intention acquiring unit that is configured to acquire a parking intention input by the user;
an inspection executing unit that is configured to execute an inspection on the autonomous driving vehicle;
an operation requesting unit that is configured to request the user to perform a predetermined operation through the fixed terminal device when the parking intention is acquired and the inspection is completed; and
an instruction transmitting unit that is configured to transmit the parking start instruction to the autonomous driving vehicle when the predetermined operation is performed through the fixed terminal device,
the program comprising instructions, when executed by the computer, causing the computer to perform:
detecting a position of the portable terminal device; and
(a) accepting an input of the parking intention when the position of the portable terminal device is within a predetermined area and (b) denying an input of the parking intention when the position of the portable terminal device is out of the predetermined area

15. A non-transitory computer readable tangible storage medium storing a parking assistance program executed on a computer included in a management device for managing entering and exiting of an autonomous driving vehicle that is configured to perform automatic driving from a drop off area in a parking lot to a parking position upon receiving a parking start instruction, the parking assistance program comprising instructions, when executed by the computer, causing the computer to perform:
acquiring a parking intention input by the user of the autonomous driving vehicle to a portable terminal device, wherein the portable terminal device is configured to communicate with the management device;
executing an inspection on the autonomous driving vehicle when acquiring the parking intention;
requesting the user to perform a predetermined operation through a fixed terminal device installed in the drop off area when the inspection is completed; and
transmitting a parking start instruction to the autonomous driving vehicle when the predetermined operation is performed through the fixed terminal device.
